(19) United States
(12) Patent Application Publication
(10) Pub. No.: US 2008/0293352 A1
(43) Pub. Date: Nov. 27, 2008

(54) IDENTIFICATION OF SELF JAMMER TONE FOR SUPPRESSION THEREOF IN RFID SYSTEMS OR THE LIKE

(76) Inventor: Joshua Posamentier, Oakland, CA (US)

Correspondence Address: COOL PATENT, P.C.;c/o INTELLEVATE, P.O. BOX 52050, MINNEAPOLIS, MN, 55402, US

(21) Appl. No.: 11/751,100

(22) Filed: May 21, 2007

(51) Int. Cl. H04K 3/00

(52) U.S. Cl. 455/1

(57) ABSTRACT

Briefly, in accordance with one or more embodiments, a self jammer may be detected and suppressed from a received signal by embedding a pilot tone in the transmitted signal and then detecting the pilot tone in the received signal. Detection of the pilot tone in the received signal indicates the presence of a self jammer. A phase shifted and attenuated version of the transmitted signal may be combined with the received signal to suppress and/or cancel the self jammer signal from the received signal.

### BACKGROUND

Full duplex radio-frequency identification (RFID) systems such as ultra-high frequency (UHF) systems operating at 900 MHz based on the various International Organization for Standardization (ISO) ISO18000-6ABC standards have to deal with a higher amplitude self jammer resulting from a powerful transmitter signal either leaking from one antenna to another in a bi-static antenna system, or from the antenna's return loss in a monostatic antenna system. This self jammer is typically present during both transmit and receive periods although it is during receive periods that desensing the receiver is an issue. In the receive mode, the jammer is a continuous wave (CW) tone down at −16 dBc to −26 dBc in a typical RFID system. In a typical 1 watt system, this equates to +4 to +15 dBm at the system port. While there are situations when other interferers may occur at higher amplitudes, removal the self jammer is capable of enhancing system performance.

### DESCRIPTION OF THE DRAWING FIGURES

Claimed subject matter is particularly pointed out and distinctly claimed in the concluding portion of the specification. However, such subject matter may be understood by reference to the following detailed description when read with the accompanying drawings in which:

FIG. 1 is a diagram of a Radio-Frequency Identification (RFID) transceiver capable of detecting and/or suppressing a self jammer tone in accordance with one or more embodiments; and

FIG. 2 is method to detect and/or suppress a self jammer tone in accordance with one or more embodiments.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

In the following description and/or claims, the terms coupled and/or connected, along with their derivatives, may be used. In particular embodiments, connected may be used to indicate that two or more elements are in direct physical and/or electrical contact with each other. Coupled may mean that two or more elements are in direct physical and/or electrical contact. However, coupled may also mean that two or more elements may not be in direct contact with each other, but yet may still cooperate and/or interact with each other. For example, “coupled” may mean that two or more elements do not contact each other but are indirectly joined together via another element or intermediate elements. The terms “on,” “overlying,” and “over” may be used in the following description and claims. “On,” “overlying,” and “over” may be used to indicate that two or more elements are in direct physical contact with each other. However, “over” may also mean that two or more elements are not in direct contact with each other. For example, “over” may mean that one element is above another element but not contact each other and may have another element or elements in between the two elements. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect. In the following description and/or claims, the terms “comprise” and “include,” along with their derivatives, may be used and are intended as synonyms for each other.

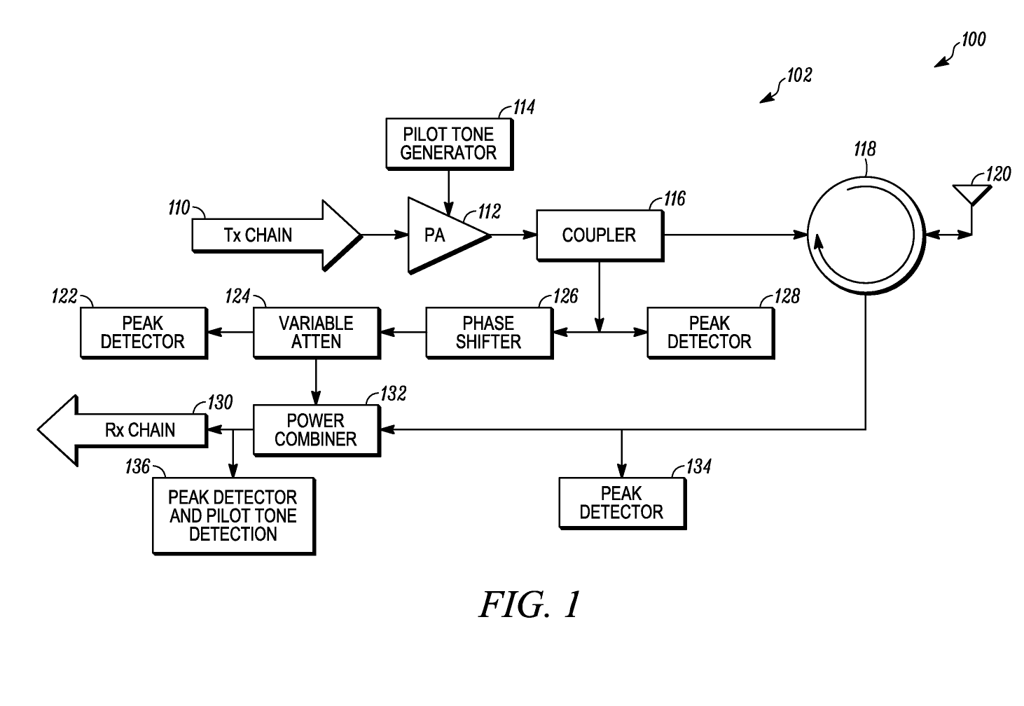

Referring now to FIG. 1, a diagram of a Radio-Frequency Identification (RFID) transceiver capable of detecting and/or suppressing a self jammer tone in accordance with one or more embodiments will be discussed. As shown in FIG. 1, transceiver 100 may comprise a jammer suppressor circuit 102, and which may comprise an ultra-high frequency (UHF) type RFID transceiver capable of interrogating an RFID tag with a 900 MHz signal that in one or more embodiments may be in compliance with a narrow band full duplex ISO 18000-6ABC standard or the like. Transceiver 100 may include antenna 120, where antenna 120 may comprise, for example, a monostatic antenna or a bistatic antenna. In one or more embodiments, transceiver 100 is capable of embedding a lower frequency, lower amplitude pilot tone in the continuous wave (CW) carrier transmitted by transceiver 100, which in turn results in the pilot tone being likewise embedded in the reflected signal received from an RFID tag (not shown) as well. Embedding of the pilot tone may be accomplished, for example, via an amplitude modulation of approximately five percent modulation depth or less, or alternatively via modulation in the frequency domain. Jammer suppressor circuit 102 may then extract the embedded pilot tone and determine which signal to suppress. Such an arrangement is capable of eliminating the signal to noise ratio (SNR) issue that co-channel jammers otherwise present. Extraction and identification of the pilot tone can be done in the analog via circuitry or in the digital domain for example via a processor (not shown) of transceiver 100, or combinations thereof, although the scope of the claimed subject matter is not limited in this respect.

In one or more embodiments, a signal to be transmitted by transceiver 100 may pass through transmitter chain 110 to a power amplifier 112 through coupler 116 to be transmitted via antenna 120. Likewise, reflected signals may be received at antenna 120 to be passed along receiver chain 130 via power combiner 132. Combiner 118 may couple and/or split signals between transmitter chain 110 and receiver chain 130. In one or more embodiments, phase shifter 126 and variable attenuator 124 may be adjusted to minimize, or nearly minimize, power detected at peak detector and pilot tone detector 136, for example via dual proportional-integrative-derivative (PID) control loops and/or adaptive perturbation control loops (not shown). Peak detector 128 monitors signals on transmitter chain 110 to provide a feedback path to control the power of the signal transmitted on transmitter chain 110. Peak detector 134 is capable of providing a reference level for an incoming jammer and/or other loud interferer signal. Peak detector 122 allows for initial power level matching to accelerate a perturbation loop convergence solution. Ultimately, minimizing, or nearly minimizing, the power at peak detector and pilot tone detection circuit 136 minimizes the self jammer injected into the receiver chain 130 which results in less desensitization and saturation yielding a higher signal to noise ratio (SNR). In one or more embodiments, pilot tone generator 114 may be arranged to perform lower amplitude modulation at one or more variable gain stages of the transmitter chain 110, for example at power amplifier 112. In an alternative embodiment, pilot tone generator 114 may perform modulation in the frequency domain which would mean modulating a voltage controlled oscillator (not shown) in the transmitter chain 110 with a very low amplitude pilot tone to slightly dither the frequency. Then, on the receiver chain 130 side, the output of the receiver chain 130, which in one or more embodiments comprises an input to an analog-to-digital converter (ADC), the output of which may be provided to a discrete Fourier transform (DFT) or a fast Fourier transform (FFT) processor to determine whether or not the jammer suppressor is functioning in the correct band, although the scope of the claimed subject matter is not limited in this respect.

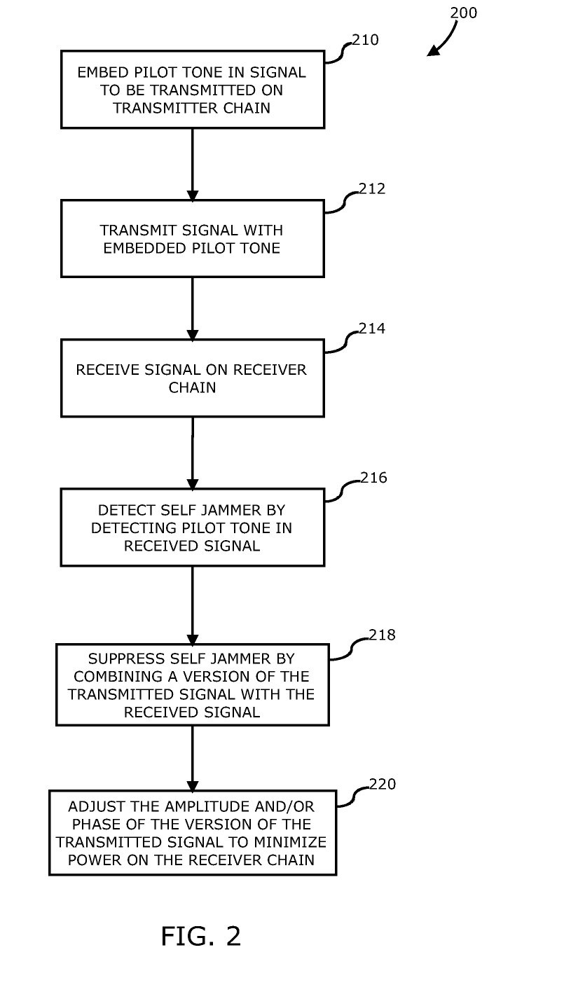

In one or more embodiments, the self jammer may be suppressed from the received signal by self jammer suppressor circuit 102 and/or by implementation of method 200 of FIG. 2 as discussed below. As shown in FIG. 1, a forward power tap may be provided by coupler 116 to provide transmit power control after the power amplifier 112. Such transmit power control may be implanted via peak detector 128 providing a feedback signal to a processor (not shown) of transceiver 100 which may adjust the power in the transmit chain 110 for example via adjusting the gain of power amplifier 112. In one or more embodiments, such a processor of transceiver 100 may couple to one or more of the element of transceiver 100 and/or jammer suppressor circuit 102 to provide control and/or processing functions to suppress the self jammer. For example, since the forward power in the transmitter chain 110 is greater than the reverse power in the receiver chain 130, the processor may control variable attenuator 124 to adjust the amplitude of the version of the transmitted signal provided to cancel out the self jammer from the received signal by combining the version of the transmitted signal with the received signal via power combiner 132. Furthermore, the phase noise present in the transmitter chain 110 likewise may be attenuated and/or canceled as s result of such an arrangement. Since the level of signal of interest, the tag response from an interrogated RFID tag, is much lower, often less than −60 dB relative to the level of the self jammer, suppression of the self jammer via jammer suppressor circuit 102 may result in enhanced performance in detecting the tag response, although the scope of the claimed subject matter is not limited in this respect.

Referring now to FIG. 2, a method to detect and/or suppress a self jammer tone in accordance with one or more embodiments will be discussed. Method 200 as shown in FIG. 2 is merely one example order of the blocks of method 200. Furthermore, method 200 may contain more or fewer blocks in one or more alternative embodiments, and the scope of the claimed subject matter is not limited in these respects. As shown in FIG. 2, a pilot tone may be embedded at block 210 in the signal to be transmitted on the transmitter chain 110 of transceiver 100. As a result, the transmitted signal may be transmitted at block 212 with the pilot tone embedded therein. A received signal may be received at block 214 on the receiver chain 130 by transceiver 100. The presence of a self jammer signal in the received signal on the receiver chain 130 may be detected at block 216 by detecting the presence of the pilot tone in the received signal. The self jammer may then be suppressed at block 218 from the received signal by combining a version of the transmitted signal with received signal to result in phase cancellation of the self jammer from the received signal. The amplitude and/or phase of the version of the transmitted signal used for such cancellation may be adjusted at block 220 to minimize, or nearly minimize, power on the receiver chain 130 which thereby minimizes, or nearly minimizes, the power of the jammer signal in the received signal. It should be noted that method 200 is merely one method for suppression of the self jammer, and the scope of the claimed subject matter is not limited in these respects.

Although the claimed subject matter has been described with a certain degree of particularity, it should be recognized that elements thereof may be altered by persons skilled in the art without departing from the spirit and/or scope of claimed subject matter. It is believed that the subject matter pertaining to identification of self jammer tone for suppression thereof in RFID systems or the like and/or many of its attendant utilities will be understood by the forgoing description, and it will be apparent that various changes may be made in the form, construction and/or arrangement of the components thereof without departing from the scope and/or spirit of the claimed subject matter or without sacrificing all of its material advantages, the form herein before described being merely an explanatory embodiment thereof, and/or further without providing substantial change thereto. It is the intention of the claims to encompass and/or include such changes.

What is claimed is:

1. A self jammer suppressor circuit for a radio-frequency identification transceiver, comprising:
a pilot tone generator to embed a pilot tone on a carrier signal to be transmitted via a transmitter chain;
a phase shifter circuit coupled between the transmitter chain and a receiver chain to provide a version of the transmitted signal to the receiver chain to be combined with a signal received on the receiver chain; and
a peak detector and pilot tone detection circuit coupled to the receiver chain to detect a self jammer signal present in the received signal by detecting the pilot tone in the received signal;
wherein the phase shifter circuit shifts the phase of the version of the transmitted signal in response to detection of the pilot tone in the received signal by the peak detector and pilot tone detection circuit to suppress the self jammer signal from the received signal.

2. A self jammer suppressor circuit as claimed in claim 1, further comprising a variable attenuator circuit coupled to the phase shifter to attenuate the version of the transmitted signal to enhance suppression of the self jammer signal from the received signal.

3. A self jammer suppressor circuit as claimed in claim 1, wherein the self jammer signal is suppressed by minimizing power of the combined signal on the receiver chain at the peak detector and pilot tone generator.

4. A self jammer suppressor circuit as claimed in claim 1, further comprising a peak detector coupled to the transmitter chain to provide power control of the transmitted signal on the transmitter chain.

5. A self jammer suppressor circuit as claimed in claim 1, further comprising a peak detector coupled to the receiver chain to provide a reference level of the self jammer signal on the receiver chain.

6. A self jammer suppressor circuit as claimed in claim 1, further comprising a peak detector circuit to receive the version of the transmitted signal to provide a reference level for power of the transmitted signal.

7. A self jammer suppressor circuit as claimed in claim 1, the pilot tone generator being capable of embedding the pilot tone signal on the transmitted wave by amplitude modulation or frequency modulation, or combinations thereof, of the transmitted signal.

8. A method to suppress a self jammer signal in a radio-frequency identification transceiver, comprising:
embedding a pilot tone on a carrier signal to be transmitted via a transmitter chain;
providing a version of the transmitted signal to the receiver chain to be combined with a signal received on the receiver chain by phase shifting the version of the transmitted signal; and
detecting a self jammer signal present in the received signal by detecting the pilot tone in the received signal;
wherein the amount of phase shift in the version of the transmitted signal is adjusted in response to the detection of the pilot tone in the received signal to suppress the self jammer signal from the received signal.

9. A method to suppress a self jammer signal as claimed in claim 8, further comprising attenuating the version of the transmitted signal to enhance suppression of the self jammer signal from the received signal.

10. A method to suppress a self jammer signal as claimed in claim 8, further comprising by minimizing power of the combined signal on the receiver chain to enhance suppression of the self jammer signal.

11. A method to suppress a self jammer signal as claimed in claim 8, further comprising providing power control of the transmitted signal on the transmitter chain.

12. A method to suppress a self jammer signal as claimed in claim 8, further comprising providing a reference level of the self jammer signal on the receiver chain.

13. A method to suppress a self jammer signal as claimed in claim 8, further comprising a providing a reference level for power of the transmitted signal.

14. A method to suppress a self jammer signal as claimed in claim 8, wherein said embedding comprises amplitude modulating or frequency modulating, or combinations thereof, the transmitted signal.
